(19) United States
(12) Patent Application Publication
(10) Pub. No.: US 2017/0120311 A1
(43) Pub. Date: May 4, 2017

(54) PORTABLE APPARATUS FOR CLEANING POTABLE WATER DEVICES

(71) Applicant: U.S. Water Systems, Indianapolis, IN (US)

(72) Inventors: Mark S. Timmons, Indianapolis, IN (US); Edward A. Knueve, Kalida, OH (US)

(73) Assignee: U.S. Water Systems, Indianapolis, IN (US)

(21) Appl. No.: 15/335,234

(22) Filed: Oct. 26, 2016

Related U.S. Application Data
(60) Provisional application No. 62/248,349, filed on Oct. 30, 2015.

(51) Int. Cl. B08B 9/032; B01D 65/02; C02F 1/00; C02F 5/00; C02F 1/44

(52) U.S. Cl. CPC B08B 9/0321; C02F 5/00; C02F 1/441; C02F 1/001; B01D 65/02; B08B 9/0326; B01D 2321/16

(57) ABSTRACT

The present invention provides methods and apparatus for cleaning and sanitizing potable water devices/appliances by recirculating and pulsing a rejuvenation solution through the device/appliance using a portable apparatus comprising a mechanical pump fluidly connected to the device/appliance.

The present application claims priority to U.S. provisional patent application 62/248,349 filed 30 Oct. 2015, which is fully incorporated herein by reference.

### FIELD OF THE INVENTION

The present invention relates to methods and apparatus for cleaning and/or sanitizing water treatment systems, such as water softeners, backwashing filters, reverse osmosis systems, backflow preventers, and many other water treatment devices.

### BACKGROUND

Water softening typically involves the removal of calcium, magnesium, and certain other metal cations in hard water. The resulting soft water is more compatible with soap and extends the lifetime of plumbing. Water softening is usually achieved using lime softening or ion-exchange resins. The most common means for removing water hardness rely on ion-exchange polymers or reverse osmosis. Other approaches include precipitation methods and sequestration by the addition of chelating agents.

Conventional water-softening appliances intended for household use depend on an ion-exchange resin in which “hardness ions”—mainly Ca²⁺ and Mg²⁺— are exchanged for sodium ions. As described by NSF/ANSI Standard 44, ion exchange devices reduce the hardness by replacing magnesium and calcium (Mg²¹ and Ca²¹) with sodium or potassium ions (Na¹ and K¹). Ion exchange resins, in the form of beads, are a functional component of domestic water softening units.

Ion exchange resins are organic polymers containing anionic and cationic functional groups to which the dications (Ca⁺⁺) bind more strongly than monocations (Na⁺). Inorganic materials called zeolites also exhibit ion-exchange properties. These minerals are widely used in laundry detergents. Resins are also available to remove carbonate, bi-carbonate and sulfate ions which are absorbed and hydroxide ions released from the resin.

When all the available Na⁺ ions have been replaced with calcium or magnesium ions, the resin must be re-charged by eluting the Ca²⁺ and Mg²⁺ ions using a solution of sodium chloride or sodium hydroxide depending on the type of resin used. For anionic resins, regeneration typically uses a solution of sodium hydroxide (lye) or potassium hydroxide. The waste waters eluted from the ion exchange column containing the unwanted calcium and magnesium salts are typically discharged to the sewage system.

Reverse osmosis (RO) takes advantage of hydrostatic pressure gradients across a special membrane. The membrane has pores large enough to admit water molecules for passage; hardness ions such as Ca²⁺ and Mg²⁺ remain behind and are flushed away by excess water into a drain. The resulting soft water supply is free of hardness ions without any other ions being added. Membranes have a limited capacity, requiring regular cleaning and/or replacement.

There are a number of kits commercially available for cleaning and descaling tankless water heaters. Such kits typically include a submersible pump, a bucket for holding water and submersing the pump, connective hoses, and cleaning or descaling solution. Examples include the Rheem RTG20124 Flush Kit, Wiseman CLENS-KIT, Flow-Aide System Descaler kit, and RYDLYME Tankless Water Heater Cleaning Kit. However, such kits are either not compatible with or will not effectively clean the related devices discussed below.

Water softeners systems and related devices require periodic maintenance, including cleaning and sanitizing. Traditionally, water treatment professionals have relied on manual methods of cleaning and sanitizing water softeners, filters, reverse osmosis systems, water coolers, back flow regulators, water dispensers, commercial coffee makers, soda machines, and ice machines, which have proven to be very inefficient and cumbersome. In these approaches, a cleaning solution is dispensed into the system and dispersed either by manual agitation (e.g., stirring or scrubbing) or by simple diffusion. These respective approaches are labor intensive and inefficient. There is most certainly a need for improved methods for cleaning and sanitizing water softener systems and related devices.

### SUMMARY

The apparatus of the present invention, through the use of an injection and recirculating pump, delivers and recirculates a cleaner, sanitizer, descaler, or any other solution needed to maintain a potable water device. Rather than simply relying on diffusion of the solution within the potable water device, the apparatus recirculates the desired solution to more efficiently distribute it throughout the entire system and increase its beneficial effect. Optional pulsation of the pump provides an additional mechanical action of the solution resulting in a scouring effect. In addition, air can be introduced into the recirculating system to induce agitation, further enhancing the efficiency of the process.

The apparatus and methods described herein allow for better and faster cleaning than has hitherto been achievable. Because the cleaning is more efficient, it is possible to reduce the amount of chemicals used, and ultimately discarded into the environment.

In a FIRST aspect, the present invention provides a method of cleaning or sanitizing a potable water device, comprising the step of: recirculating a rejuvenating solution through the potable water device. The unique design of this product allows the cleansing and sanitizing solutions to be directly injected into the bottom of the water softener or backwashing filter bed, which promotes a more concentrated solution to be applied to the point of the greatest contamination.

In a 1^{st} embodiment, the method further comprises the step of: pulsing the rejuvenating solution through the potable water device.

In a 2^{nd} embodiment, the method further comprises the step of: injecting the rejuvenating solution into the potable water device.

In a 3^{ed} embodiment, the rejuvenating solution is a cleaning, sanitizing or descaling solution.

In a 4^{th} embodiment, the cleaning solution comprises proprietary cleansing and sanitizing compounds.

In a 5^{th} embodiment, the sanitizing solution comprises an oxidizing agent (including peroxides, such as hydrogen peroxide, sodium percarbonate, or peracetic acid), reducing agent (such as sodium dithionite or sodium borohydride), sodium or calcium hypochlorite, sodium perborate, formaldehyde, ozone, potassium permanganate, iodine, a chlorine-like oxidant (such as such as 1,3-dichloro- or 5,5-dimethylhydantion) as an active ingredient, or any combination thereof. In a preferred embodiment, the sanitizing solution is a bleach.

In a 6^{th} embodiment, the descaling solution comprises an acidic compound such as citric acid, formic acid, glycolic acid, hydrochloric acid, phosphoric acid, sulfamic acid or acetic acid as an active ingredient, or any combination thereof. A preferred active ingredient is hydrochloric acid.

In a 7^{th} embodiment, the potable water device is a water softener, filter, reverse osmosis system, water cooler, back flow regulator, water dispenser, commercial coffee maker, soda machine, or ice machine.

In an 8^{th} embodiment, the potable water device is a water softener.

In a 9^{th} embodiment, the potable water device is a reverse osmosis system.

In an 10^{th} embodiment, the recirculation, pulsing and injecting are performed by a detachable, portable apparatus comprising: a pump fluidly connected to the potable water device, provided the pump is not a submersible pump.

In a 11^{th} embodiment, the pump is a mechanical pump.

In a 12^{th} embodiment, the pump is electrically and/or battery powered.

In a 13^{th} embodiment, the pump is fluidly connected to the potable water device by flexible tubing.

In a 14^{th} embodiment, the apparatus further comprises a diverter valve.

In a 15^{th} embodiment, the apparatus further comprises a check valve.

In a 16^{th} embodiment, the apparatus further comprises a solution bag connection fitting.

In a 17^{th} embodiment, the apparatus further comprises a solution bag connection fitting with an integrated check valve.

In an 18^{th} embodiment, the diverter valve is used to introduce air into the recirculation system to induce agitation.

In a SECOND aspect, the present invention provides an apparatus for cleaning or sanitizing a potable water device, comprising: a pump to recirculate and/or pulsate a rejuvenating solution through the device, provided the pump is not a submersible pump.

In a 2^{nd} embodiment, the pump is a mechanical pump.

In a 3^{rd} embodiment, the pump is electrically and/or battery powered.

In a 4^{th} embodiment, the apparatus further comprises detachable means to fluidly connect the pump to the potable water device.

In a 5^{th} embodiment, the apparatus further comprises detachable flexible inlet and outlet tubes to fluidly connect the pump to inlet and outlet ports, respectively, of the potable water device.

In a 6^{th} embodiment, the inlet and outlet tubes are ⅜″ Chemical Resistant tubing.

In a 7^{th} embodiment, the apparatus further comprises a diverter valve.

In an 8^{th} embodiment, the apparatus further comprises a check valve.

In a 9^{th} embodiment, the apparatus further comprises a solution bag connection fitting.

In a 10^{th} embodiment, the apparatus further comprises a solution bag connection fitting with an integrated check valve.

In an 11^{th} embodiment, the apparatus is portable.

It will be appreciated that all allowable combinations of the above aspects and embodiments (along with all other aspects and embodiments disclosed elsewhere herein) are contemplated as further inventions by Applicants.

### BRIEF DESCRIPTION OF THE DRAWINGS

FIG. 1 shows an embodiment of a portable cleaning apparatus of the invention.

FIG. 2 shows the components underneath a faceplate of the portable cleaning apparatus of the invention depicted in FIG. 1.

FIG. 3 shows a schematic of the cleaning apparatus of the invention connected to the resin filled tank of a water softener.

FIG. 4 shows an embodiment of a filter system attachment of the invention.

FIG. 5 shows another embodiment of a portable cleaning apparatus of the invention.

FIG. 6 shows the components underneath a faceplate of the portable cleaning apparatus of the invention depicted in FIG. 5.

### DETAILED DESCRIPTION

### Overview

The present invention provides methods and apparatus to clean and/or sanitize a potable water device, such as a water softener, drinking water system, reverse osmosis system, backwashing filter, backflow preventer, plumbing system or loop. The portable apparatus of the invention generally includes a pump, tubing, connectors and a series of valves to introduce a rejuvenating solution into the potable water device and recirculate the solution therein. In a preferred embodiment, the pump further creates a pulsing (or vibrating) action which effectively scrubs the internals so as to more effectively clean, remove biofilm, bacteria, limescale or other contaminants and increase efficiency and operational ability of the device. In another preferred embodiment, air is introduced into the circulating fluid to increase agitation. This combination ofrecirculation, pulsing action, and agitation provides cleaning and sanitizing efficiencies which have has not hitherto been possible.

### Potable Water Devices

As used herein, the term “potable water device” refers to a home or business appliance that utilizes or produces a clean water source. Examples include, but are not limited to, water softeners, filters, reverse osmosis systems, water coolers, water heaters, back flow regulators, water dispensers, commercial coffee makers, soda machines, and ice machines. The methods and apparatus of the invention are not intended to apply to large-scale, industrial, commercial water purification systems and similar machines.

In preferred embodiment, the potable water device is a reverse osmosis system or a water softener.

Reverse Osmosis Systems

Historically, reverse osmosis manufacturers recommended the use of sanitizing wipes or cleaners to manually wash filter and membrane housings. The inability to directly contact all surfaces including tubing, storage tanks, and delivery lines results in an incomplete sanitizing of the system by this approach. However, the apparatus of the present invention recirculates sanitizer throughout the entire system, resulting in complete sanitation.

Water Softeners

There are presently no other systems available that recirculate cleaner throughout the entire resin bed of a conventional water softener. Typically, the cleaner solution is drawn into the brine line, where it's diluted by the water needed to create the vacuum. Once the cleaning solution is in the resin tank, there is no way to move the cleaner throughout the resin without further diluting it. In contrast, the apparatus of the present invention delivers and recirculates the cleaning solution without adding additional water. In many cases, the apparatus delivers the solution to the bottom of the filter and/or resin bed for the greatest efficiency.

### Need to Periodically Clean and Sanitize Devices

Water softener resin is extremely porous, which is beneficial because it allows for more surface area to capture calcium and other metals in source water. Surprisingly, 99% of ion exchange actually happens in the interior of the bead. Resin beads, ranging in size from 16 to 50 mesh, are abused daily during the backwash process and by contaminants in the source water. Resin could last much longer in these hostile environments with a few fairly inexpensive solutions.

Resin life varies based on several factors, such as the type of resin used, the minerals or oxidants present in the source water, and the regeneration cycle. Organic fouling is the most common and expensive form of resin fouling and degradation. Well water is typically low in organic materials, but surface waters contain hundreds of parts per million of natural and manmade organic matter.

Natural organics are formed from decaying materials and are usually acidic and have an odor. The most typical natural contaminants include tannins, oils, tannic acid and fulvic acid. These contaminants plug the interiors of beads, causing a fish eye effect. If these organics remain on the resin, they break down the strong base of the beads until they are no longer active. At this stage, cleaning the resin can return some of the lost capacity, but the ability to remove silica and carbonic acid will be lost.

In situations in which iron or manganese is present, organic fouling is accelerated. Ferrous iron exchanges ions and attaches itself to resin the same way as hardness minerals. However, a brine solution alone will not dislodge iron ions from resin beads. The iron is oxidized as air is introduced into the system, and the now-ferric iron attaches itself to the surface of the bead as well. The beads will stick to one another, causing channeling. This restricts the flow of water over the resin to specific arteries that form over time in the resin tank, reducing the exchange capacity of the tank to as low as 10%. Manganese fouls resin in the same manner as iron.

Resin can become fouled with contaminants that hinder the exchange process. The resin can also be attacked by chemicals that cause irreversible destruction. Some materials, such as natural organics, foul resins at first and then degrade the resin as time passes. This is the most common cause of fouling and degradation in ion exchange systems. There are numerous causing of fouling

Iron and Manganese.

Iron may exist in water as a ferrous or ferric inorganic salt or as a sequestered organic complex. Ferrous iron exchanges in resin, but ferric iron is insoluble and does not. Ferric iron coats cation resin, preventing exchange. An acid or a strong reducing agent must be used to remove this iron. Organically bound iron passes through a cation unit and fouls the anion resin. It must be removed along with the organic material. Manganese, present in some well waters, fouls a resin in the same manner as iron.

Aluminum.

Aluminum is usually present as aluminum hydroxide, resulting from alum or sodium aluminate use in clarification or precipitation softening. Aluminum floc, if carried through filters, coats the resin in a sodium zeolite softener. It is removed by cleaning with either acid or caustic. Usually, aluminum is not a foulant in a demineralizer system, because it is removed from the resin during a normal regeneration.

Hardness Precipitates.

Hardness precipitates carry through a filter from a precipitation softener or form after filtration by post-precipitation. These precipitates foul resins used for sodium zeolite softening. They are removed with acid.

Sulfate Precipitation.

Calcium sulfate precipitation can occur in a strong acid cation unit operated in the hydrogen cycle. At the end of a service cycle, the top of the resin bed is rich in calcium. If sulfuric acid is used as the regenerant, and it is introduced at too high a concentration or too low a flow rate, precipitation of calcium sulfate occurs, fouling the resin. After calcium sulfate has formed, it is very difficult to redissolve; therefore, resin fouled by calcium sulfate is usually discarded. Mild cases of calcium sulfate fouling may be reversed with a prolonged soak in hydrochloric acid.

Barium sulfate is even less soluble than calcium sulfate. If a water source contains measurable amounts of barium, hydrochloric acid regeneration should be considered.

Oil Fouling.

Oil coats resin, blocking the passage of ions to and from exchange sites. A surfactant can be used to remove oil. Care must be exercised to select a surfactant that does not foul resin. Oil-fouled anion resins should be cleaned with nonionic surfactants only.

Microbiological Fouling.

Microbiological fouling can occur in resin beds, especially beds that are allowed to sit without service flow. Microbiological fouling can lead to severe plugging of the resin bed, and even mechanical damage due to an excessive pressure drop across the fouled resin. If microbiological fouling in standby units is a problem, a constant flow of recirculating water should be used to minimize the problem. Severe conditions may require the application of suitable sterilization agents and surfactants. Ion exchange resin beds are often an attractive growth medium for biological organisms, such as bacteria, mold and algae. In some cases, these growths can build up in the resin bed and physically foul the resin. In most cases, however, the concern is that these organisms will contaminate the effluent water leaving the ion exchange system. Microbes feed on the traces of organic matter, nitrates and ammonia that are absorbed and concentrated by ion exchange beads. Therefore, ion exchange units that run for long periods of time between regenerations can support microbial growth. Conversely, when ion exchange resins are idle for long periods of time (months or years), they can become sources of microbial growth. Both of these situations can cause microbial counts in the effluent of an ion exchanger to be higher than the influent. Normal regeneration of demineralizer resins with acid or caustic subjects the resin to pH extremes, which can act as a sanitization step. Regeneration with salt brine, however, does little or nothing to reduce bacteria.

Silica Fouling.

Silica fouling can occur in strong base anion resins if the regenerant temperature is too low, or in weak base resins if the effluent caustic from the SBA unit used to regenerate the weak base unit contains too much silica. At low pH levels, polymerization of the silica can occur in a weak base resin. It can also be a problem in an exhausted strong base anion resin. Silica fouling is removed by a prolonged soak in warm (120° F.) caustic soda.

Organic Fouling is the most common and expensive form of resin fouling and degradation. Usually, only low levels of organic materials are found in well waters. However, surface waters can contain hundreds of parts per million of natural and man-made organic matter. Natural organics are derived from decaying vegetation. They are aromatic and acidic in nature, and can complex heavy metals, such as iron. These contaminants include tannins, tannic acid, humic acid, and fulvic acid. Organic fouling of anion resin is evidenced by the color of the effluent from the anion unit during regeneration, which ranges from tea-colored to dark brown. During operation, the treated water has higher conductivity and a lower pH.

### Rejuvenation Solutions

As used herein, the term “rejuvenating solution” refers to a cleaning, sanitizing, descaling, or any other solution needed to maintain or recondition a potable water device. Such solutions are well known in the art, and a wide variety are commercially available.

For the chemical treatment of water a great variety of chemicals can be applied, including but not limited to algaecides, antifoams, biocides, boiler water chemicals, coagulants, corrosion inhibitors, disinfectants, flocculants, neutralizing agents, oxidants, oxygen scavengers, pH conditioners, resin cleaners, and scale inhibitors.

Algaecides are chemicals that kill algae and blue or green algae, when they are added to water. Examples are copper sulfate, iron salts, rosin amine salts and benzalkonium chloride. Algaecides are effective against algae, but are not very usable for algal blooms for environmental reasons. A problem associated with most algaecides is that they kill all present algae, but they do not remove the toxins that are released by the algae prior to death.

Foam is a mass of bubbles created when certain types of gas are dispersed into a liquid. Strong films of liquid than surround the bubbles, forming large volumes of non-productive foam. The cause of foam is a complicated study in physical chemistry, but we already know that its existence presents serious problems in both the operation of industrial processes and the quality of finished products. When it is not held under control, foam can reduce the capacity of equipment and increase the duration and costs of processes. Antifoam blends contain oils combined with small amounts of silica. They break down foam thanks to two of silicone's properties: incompatibility with aqueous systems and ease of spreading. Antifoam compounds are available either as powder or as an emulsion of the pure product.

Antifoam powder covers a group of products based on modified polydimethylsiloxane. The products vary in their basic properties, but as a group they introduce excellent antifoaming in a wide range of applications and conditions.

The antifoams are chemically inert and do not react with the medium that is defoamed. They are odourless, tasteless, non-volatile, non-toxic and they do not corrode materials. The only disadvantage of the powdery product is that it cannot be used in watery solutions.

Antifoam Emulsions are aqueous emulsions of polydimethylsiloxane fluids. They have the same properties as the powder form, the only difference is that they can also be applied in watery solutions.

Biocides are chemical compounds that are toxic to the present microrganisms. Biocides are usually slug fed to a system to bring about rapid effective population reductions from which the microrganisms cannot easily recover. There are various different biocides, some of which have a wide range of effect on many different kinds of bacteria. They can be divided up into oxidising agents and non-oxidising agents. Oxidizing agents include chlorine, chlorine dioxide, chloroisocyanurates, hypochlorite and ozone. Non-oxidizing agents include acrolein, amines, chlorinated phenolics, copper salts, organo-sulfur compounds, and quaternary ammonium salts.

Boiler water chemicals include all chemicals that are used for the following applications: oxygen scavenging, scale inhibition, corrosion inhibition, antifoaming, and alkalinity control.

When referring to coagulants, positive ions with high valence are preferred. Generally aluminum and iron are applied, aluminum as Al₂(SO₄)³⁻ and iron as either FeCl₃ or Fe₂(SO₄)³⁻. One can also apply the relatively cheap form FeSO⁴, on condition that it will be oxidized to Fe³⁺ during aeration. Coagulation is very dependent on the doses ofcoagulants, the pH and colloid concentrations. To adjust pH levels Ca(OH)₂ is applied as co-flocculent. Doses usually vary between 10 and 90 mg Fe³⁺/L, but when salts are present a higher dose needs to be applied.

Corrosion is a general term that indicates the conversion of a metal into a soluble compound. Corrosion can lead to failure of critical parts of boiler systems, deposition of corrosion products in critical heat exchange areas, and overall efficiency loss.

That is why corrosion inhibitors are often applied. Inhibitors are chemicals that react with a metallic surface, giving the surface a certain level of protection. Inhibitors often work by adsorbing themselves on the metallic surface, protecting the metallic surface by forming a film.

There are five different kinds of corrosion inhibitors. 1) Passivity inhibitors (passivators). These cause a shift of the corrosion potential, forcing the metallic surface into the passive range. Examples of passivity inhibitors are oxidizing anions, such as chromate, nitrite and nitrate and non-oxidizing ions such as phosphate and molybdate. These inhibitors are the most effective and consequently the most widely used. 2) Cathodic inhibitors. Some cathodic inhibitors, such as compounds of arsenic and antimony, work by making the recombination and discharge of hydrogen more difficult. Other cathodic inhibitors, ions such as calcium, zinc or magnesium, may be precipitated as oxides to form a protective layer on the metal. 3) Organic inhibitors. These affect the entire surface of a corroding metal when present in certain concentration. Organic inhibitors protect the metal by forming a hydrophobic film on the metal surface. Organic inhibitors will be adsorbed according to the ionic charge of the inhibitor and the charge on the surface. 4) Precipitation inducing inhibitors. These are compounds that cause the formation of precipitates on the surface of the metal, thereby providing a protective film. The most common inhibitors of this category are silicates and phosphates. 5) Volatile Corrosion Inhibitors (VCI). These are compounds transported in a closed environment to the site of corrosion by volatilisation from a source. Examples are morpholine and hydrazine and volatile solids such as salts of dicyclohexylamine, cyclohexylamine and hexamethylene-amine. On contact with the metal surface, the vapour of these salts condenses and is hydrolysed by moisture to liberate protective ions.

Disinfectants kill present unwanted microrganisms in water. There are various different types of disinfectants, such as chlorine (dose 2-10 mg/L), chlorine dioxide, ozone and hypochlorite. ClO₂ is used principally as a primary disinfectant for surface waters with odor and taste problems. It is an effective biocide at concentrations as low as 0.1 ppm and over a wide pH range. ClO₂ penetrates the bacterial cell wall and reacts with vital amino acids in the cytoplasm of the cell to kill the organisms. The by-product of this reaction is chlorite. Chlorine dioxide disinfects according to the same principle as chlorine, however, as opposed to chlorine, chlorine dioxide has no harmful effects on human health. Hypochlorite is applied in the same way as chlorine dioxide and chlorine. Hypo chlorination is a disinfection method that is not used widely anymore, since an environmental agency proved that the Hypochlorite for disinfection in water was the cause of bromate consistence in water. Ozone is a very strong oxidation medium, with a remarkably short life span. It consists of oxygen molecules with an extra O-atom, to form O₃. When ozone comes in contact with odour, bacteria or viruses the extra O-atom breaks them down directly, by means of oxidation. The third O-atom of the ozone molecules is then lost and only oxygen will remain.

To promote the formation of flocs in water that contains suspended solids, polymer flocculants (polyelectrolytes) are applied to promote bonds formation between particles. These polymers have a very specific effect, dependent upon their charges, their molar weight and their molecular degree of ramification. The polymers are water-soluble and their molar weight varies between 10⁵ and 10⁶ g/mol. There can be several charges on one flocculent. There are cationic polymers, based on nitrogen, anionic polymers, based on carboxylate ions and polyampholytes, which carry both positive and negative charges.

In order to neutralize acids and basics, sodium hydroxide solution (NaOH), calcium carbonate, or lime suspension (Ca(OH)₂) is generally used to increase pH levels. Sulphuric acid (H₂SO₄) or diluted hydrochloric acid (HCl) is generally used to decrease pH levels. The dose of neutralizing agents depends upon the pH of the water in a reaction basin. Neutralization reactions cause a rise in temperature.

Chemical oxidation processes use (chemical) oxidants to reduce COD/BOD levels, and to remove both organic and oxidisable inorganic components. The processes can completely oxidise organic materials to carbon dioxide and water, although it is often not necessary to operate the processes to this level of treatment. A wide variety of oxidation chemicals are available. Examples are hydrogen peroxide, ozone, combined ozone & peroxide, and oxygen. Hydrogen peroxide is widely used thanks to its properties: it is a safe, effective, powerful and versatile oxidant. The main applications of H₂O₂ are oxidation to aid odor control and corrosion control, organic oxidation, metal oxidation and toxicity oxidation. The most difficult pollutants to oxidize may require H₂O₂ to be activated with catalysts such as iron, copper, manganese or other transition metal compounds. Ozone cannot only be applied as a disinfectant; it can also aid the removal of contaminants from water by means of oxidation. Ozone then purifies water by breaking up organic contaminants and converting inorganic contaminants to an insoluble form that can then be filtered out. The Ozone system can remove up to twenty-five contaminants. Oxygen can also be applied as an oxidant, for instance to realize the oxidation of iron and manganese.

Oxygen scavenging means preventing oxygen from introducing oxidation reactions. Most of the naturally occurring organics have a slightly negative charge. Due to that they can absorb oxygen molecules, because these carry a slightly positive charge, to prevent oxidation reactions from taking place in water and other liquids. Oxygen scavengers include both volatile products, such as hydrazine (N₂H₄) or other organic products like carbohydrazine, hydroquinone, diethylhydroxyethanol, and methylethylketoxime, but also non-volatile salts, such as sodium sulphite (Na₂SO₃) and other inorganic compounds, or derivatives thereof. The salts often contain catalysing compounds to increase the rate of reaction with dissolved oxygen, for instance cobalt chloride.

Municipal water is often pH-adjusted, in order to prevent corrosion from pipes and to prevent dissolution of lead into water supplies. During water treatment pH adjustments may also be required. The pH is brought up or down through addition of basics or acids. An example of lowering the pH is the addition of hydrogen chloride, in case of a basic liquid. An example of bringing up the pH is the addition of natrium hydroxide, in case of an acidic liquid. The pH will be converted to approximately seven to seven and a half, after addition of certain concentrations of acids or basics. The concentration of the substance and the kind of substance that is added, depend upon the necessary decrease or increase of the pH.

The rejuvenating solution of the present invention is preferably a cleaning, sanitizing or descaling solution.

### Examples of Cleaning Solutions

Ion exchange resins need to be regularly regenerated between applications, so that they can be reused. But every time the ion exchangers are used serious fouling takes place. The contaminants that enter the resins will not be removed through regeneration; therefore resins need cleaning with certain chemicals. Chemicals that are used include sodium chloride, potassium chloride, citric acid, and chlorine dioxide. Chlorine dioxide cleansing serves the removal of organic contaminants on ion exchange resins.

Iron and manganese can be left on the resin after regeneration and will continue to accumulate cycle after cycle. The traditional cleaning reagents are sulfamic acid, hydrochloric acid, citric acid, phosphoric acid, acetic acid and sodium hydrosulfite.

### Examples of Sanitizing Solutions

Sterilization with bleach (or with other chemicals that release chlorine as the active oxidant) is an inexpensive method to kill most biological foulants. The degree of risk to most ion exchange resins associated with short-term exposure to chlorine is minimal. One-hour exposure to high concentrations of bleach does not severely degrade ion exchange resins; although, some damage occurs. Short exposures to concentrations of 50 to 100 ppm do not measurably harm ion exchange resins and generally do a good job sterilizing the resin.

Hydrogen peroxide can also be used to sterilize resin. By itself, hydrogen peroxide does not damage ion exchange resins, even at concentrations approaching 10%. The presence of iron fouling (or other metals), however, causes hydrogen peroxide to decompose. The decomposition is exothermic and occurs more rapidly when temperatures are elevated. This can result in a runaway reaction where the temperature approaches boiling and/or reaches explosive composition.

Other oxidants that are sometimes used to sterilize resin beds include ozone, potassium permanganate, iodine and a host of chlorine-like oxidants (such as 1,3-dichloro- and 5,5-dimethylhydantion). By and large, these are all effective and relatively safe; however, the plastic and rubber materials that are commonly used in ion exchange systems may not be impervious to oxidation. Ozone in particular will rapidly degrade some plastic materials. Another consideration is the possibility that there may be other foulants on the resin that act as catalysts, increasing the rate of oxidation.

### Examples of Descaling Solutions

Scale is the precipitate that forms on surfaces in contact with water as a result of the precipitation of normally soluble solids that become insoluble as temperature increases. Some examples of scale are calcium carbonate, calcium sulfate, and calcium silicate. Scale inhibitors are surface-active negatively charged polymers. As minerals exceed their solubility's and begin to merge, the polymers become attached. The structure for crystallisation is disrupted and the formation of scale is prevented. The particles of scale combined with the inhibitor will then be dispersed and remain in suspension.

Examples of scale inhibitors are phosphate esters, phosphoric acid and solutions of low molecular weight polyacrylic acid.

A descaling agent or chemical descaler is a chemical substance used to remove limescale from metal surfaces in contact with hot water, including but not limited to boilers, water heaters, and kettles. Descaling agents are typically acidic compounds such as hydrochloric acid that react with the alkaline carbonate compounds present in the scale, producing carbon dioxide gas and a soluble salt. Notable descaling agents include citric acid, formic acid, glycolic acid, hydrochloric acid, phosphoric acid, sulfamic acid and acetic acid.

The following Examples are intended to provide specific working embodiments of the apparatus and methods of the invention. They are in no way intended to limit the scope of the invention.

### Exemplary Apparatus of the Invention

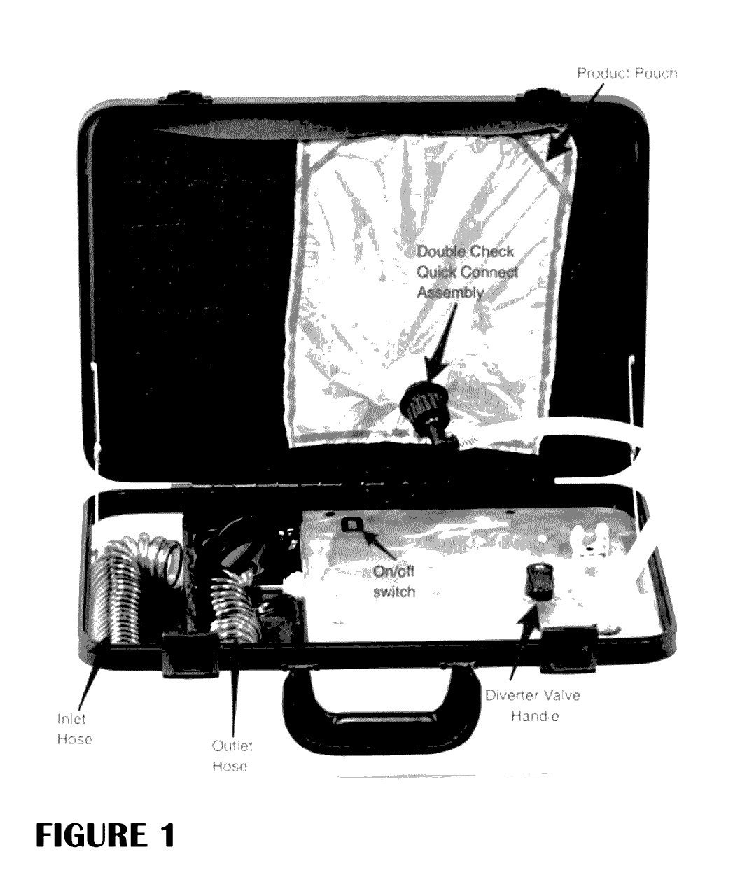

FIGS. 1-6 illustrate one embodiment of an apparatus of the invention. The apparatus includes a carrying case approximately 18″×13″×8″. Contained within the heavy-duty protective carrying case is a diaphragm pump, diverter valve, check valve, inlet hose, exit hose, and fittings to connect the apparatus to water treatment devices.

FIG. 1 shows a solution bag attached to the apparatus via a double check quick connect assembly. These bags can contain solutions of volumes, compositions and concentrations suitable for the specific cleaning and/or sanitizing application desired. The solution bag connection fitting is both sanitary and contains a check valve which prevents water from entering the bag. The solution bag is designed to hang on the case and dispense one liter of chemical.

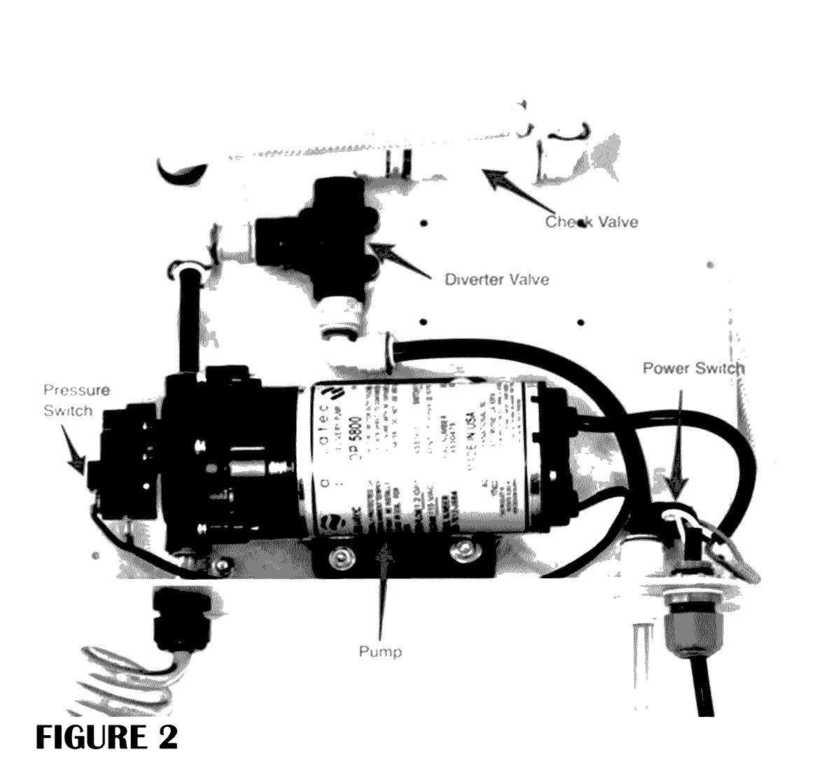

As shown in FIG. 2, the pump, electrical connections, diverter valve, and plumbing connections are contained underneath a faceplate within the case constructed of 11 ga. aluminum. The pump is a diaphragm pump operating on 120 V controlled by a single pole switch mounted within the faceplate. The pump is capable of delivering pulsating flows from 1 to 5 GPM. Applicants have unexpectedly discovered that such diaphragm pumps provide a pulsating action which assists in the cleaning process. This pulsating action would normally be considered undesirable for traditional uses of such pumps.

The suction line of the pump runs from the pump to the three-way diverter valve. The three-way diverter valve has connections to the injection tubing and suction line. The injection tubing runs from the diverter valve through a one way check valve up through the faceplate and terminates with a quick connect fitting with integrated check valve for attachment to the dispensing bag. The suction line runs from the diverter valve through the faceplate and is attached to an 8 foot section of coiled chemical resistant ⅜ tubing. The delivery line runs from the pump through the faceplate to another 8 foot piece of coiled chemically resistance ⅜ tubing. Mounted to the interior portion of the lid of the case are two attachments from which to hang the solution bags.

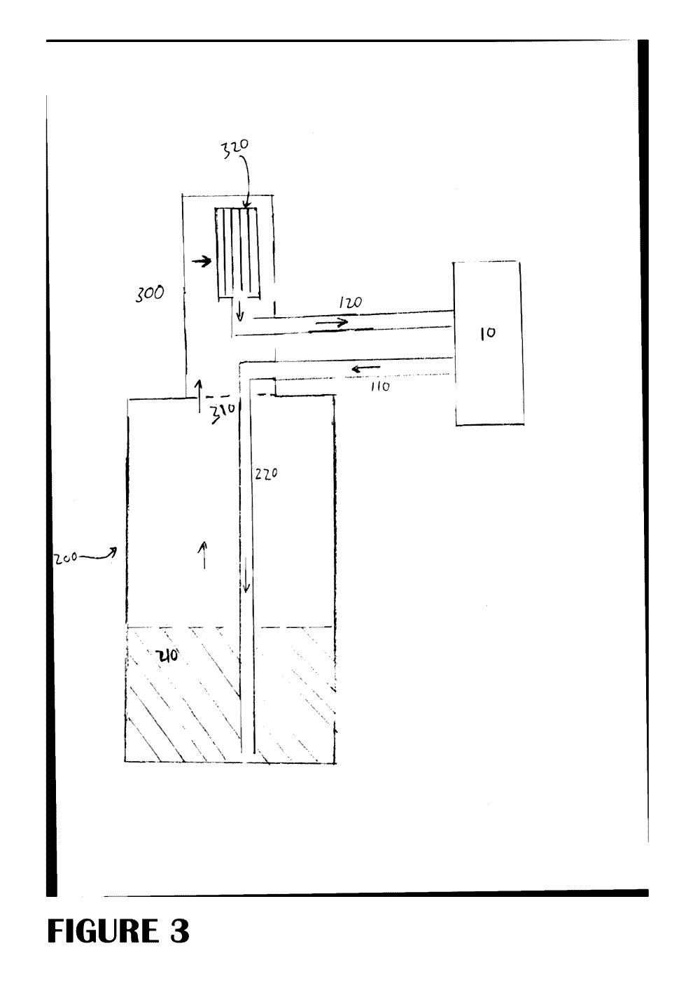

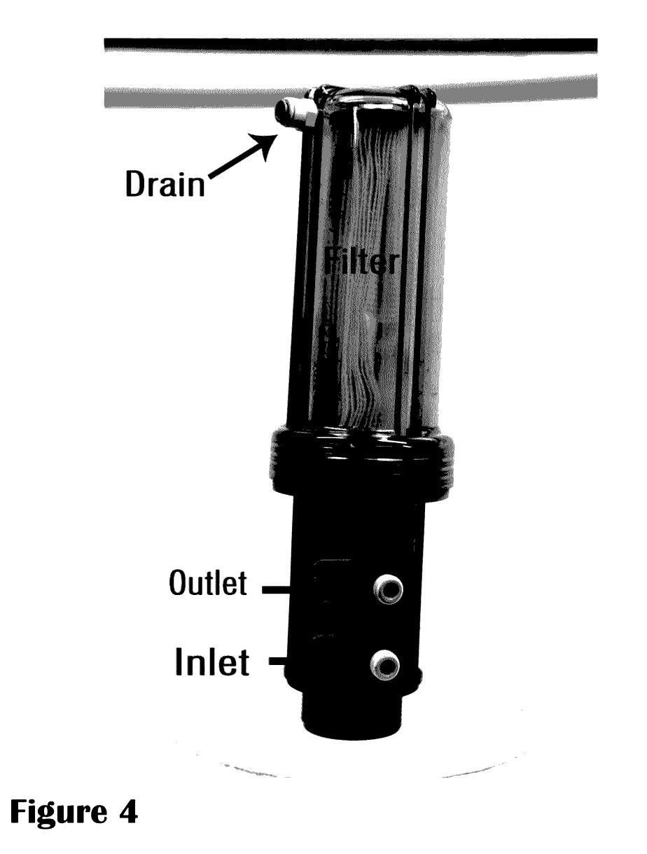

FIG. 3 shows a schematic of the cleaning apparatus of the invention 100 connected to the resin filled tank of a water softener 200, containing resin in its lower section 210. In this embodiment, the head of the water softener has been removed and temporarily replaced with a filter system attachment 300 (see FIG. 4) to assist in cleaning.

The cleaning apparatus is connected to the downtube 220 of the tank 200 by inlet hose 110. The pump forces liquid down the downtube 220 to the bottom of the tank. The water then flows up though the resin in the lower section and continues upward. The water exits the tank through openings 310 in the bottom of the filter system attachment 300. The water is then forced through a disposable filter 320, which captures released contaminants. The filtered water then exits the filter system attachment 300 and returns into the cleaning apparatus 100 via an outlet hose 120.

Recirculation is continued until the resin is cleaned and/or sanitized. At that time, the inlet 110 and outlet 120 hoses are disconnected, the filter system attachment 300 is removed, the contaminated filter is discarded, and the water softener head is replaced on the tank.

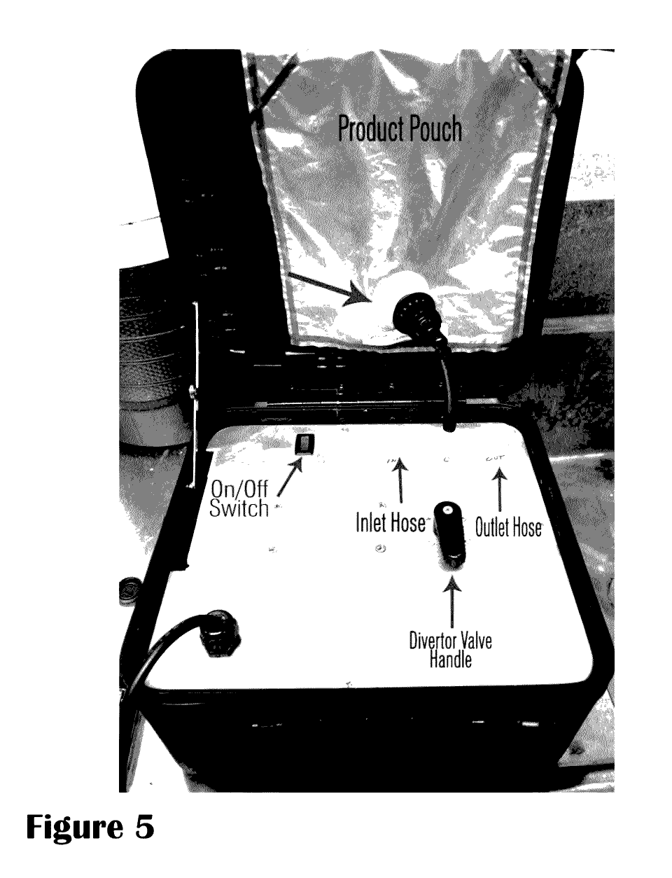

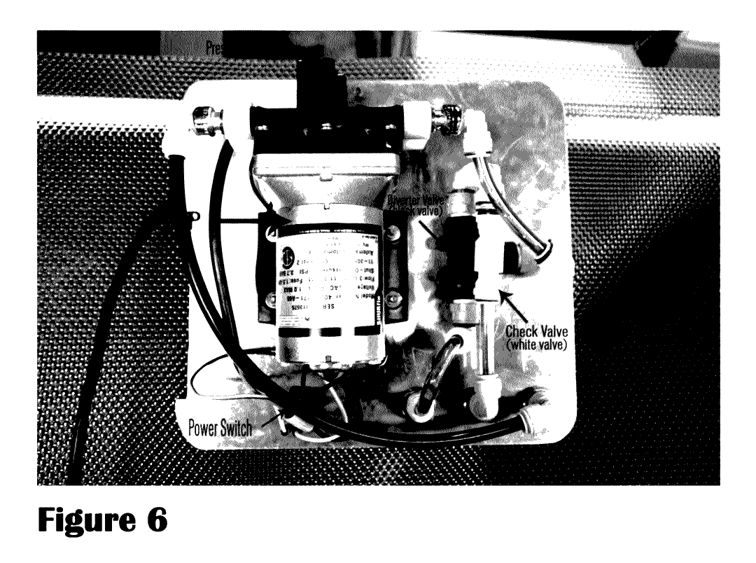

FIG. 5 shows another embodiment of a portable cleaning apparatus of the invention with relevant components labeled. FIG. 6 shows the components underneath a faceplate of the portable cleaning apparatus of the invention depicted in FIG. 5.

These apparatus are suitable for use with the following associated methods, wherein the apparatus is referred to as the “Water Paramedic system.”

### Exemplary Methods of the Invention

### Backwashing Filter Cleaning Procedures

Filter cleaning is an important maintenance step and can dramatically increase the longevity of effective treatment from the media used in the filter. Most filters operate in the “downflow” position. This means that the water enters at the top of the tank and is slow pushed through the media bed to the bottom distributor tube then back up and out of the filter. Due to the nature of this operation, the highest impacted media is at the top of the tank. When introducing cleaner to the top of the filter tank, the residual water at the top of the tank comingles with the cleaning solution and dilutes it. For this reason the method used to clean the backwashing filter is performed in reverse (upflow) to ensure the concentrated chemical is not diluted or spent in by introducing it to the bottom of the filter where the media is typically the least impacted. This makes sure the media is dosed at the highest cleaning concentration for the entire process. Large amounts of removed contaminants can then be flushed to the drain and removed from the system.

### Cleaning Procedure

Turn off the main water supply and open a faucet of spigot downstream of the filter. Initiate a backwash process and allow the water system to drain. Disconnect the filter drain at the control valve on the top of the tank and attach the Water Paramedic injection line to the drain line connection on the filter control valve. Advance the filter to the rinse position. Once in the rinse position activate the pump to inject the cleaning solution in the filter. It should be noted that advancing the control valve to the rinse cycle will reverse the drain line flow and allow the cleaning solution to be injected in the bottom of the filter tank via the drain line. When the cleaning solution has been fully injected in the system, stop the water para-medic pump and disconnect the injection line. Re-attach the backwashing filter drain line and shut the downstream faucet. Slowly open the supply valve to allow 2-3 gallons of water into the system and out of the drain.

Larger tanks may require 5-7 gallons of water allowed into the system. This water is what is needed to ensure the chemical reaches the top of the media bed. Allow the system to rest with the concentrated solution in the tank. After the 30 minutes the control valve should be back in the “service” position. Now start the unit into a normal backwash and allow it to backwash and rinse for the full cycle times. Check the water quality and backwash and rinse again if necessary. If there is still residual contaminants being discharged after a second backwash, repeat the cleaning procedure from the beginning. In older models with neglected maintenance, this procedure must be performed more than once. In some cases, the media cannot be saved and must be replaced.

### Backwashing Filter Sanitizing Procedures

Anytime a service is performed or a water system and it is opened to the atmosphere, a sanitization process should be performed to ensure there is no cross contamination from tools, hands and ambient air. Sanitizing is expected to ensure organics in the filter are destroyed and the system is biologically safer.

### Sanitizing Procedure

Turn off the main water supply and open a faucet of spigot downstream of the filter. Initiate a backwash process and allow the water system to drain. Disconnect the filter drain at the control valve on the top of the tank and attach the Water Paramedic injection line to the drain line connection on the filter control valve. Advance the filter to the rinse position. Once in the rinse position activate the pump to inject the sanitizing solution in the filter. It should be noted that advancing the control valve to the rinse cycle will reverse the drain line flow and allow the sanitizing solution to be injected in the bottom of the filter tank via the drain line. When the sanitizing solution has been fully injected in the system, stop the water para-medic pump and disconnect the injection line. Re-attach the backwashing filter drain line and shut the downstream faucet. Turn on the main water supply on and start a backwash process. Allow the filter to backwash for 3 minutes and turn off the water supply again. Allow the system to rest with the concentrated solution in the tank. After the 30 minutes the control valve should be back in the “service” position. Now start the unit into a normal backwash and allow it to backwash and rinse for the full cycle times. Check the water and ensure the sanitizing solution has been flushed. Backwash and rinse again if necessary. Be sure the water is running clear and there is no residual sanitizing chemical left in the system.

### Water Softener Cleaning Procedures

A water softener is used to remove calcium and magnesium from a feed water source. Although these element are not a health risk, they are very troublesome for other appliances and fixtures in the plumbing system. Water softeners can become fouled with organic material and in some cases, contaminants from other elements. Water softeners are sometimes used to remove/polish other contaminants such as iron and manganese. Cleaning these contaminants from the resin will improve the water softener operation as well as ensure organic fouling can be removed.

### Cleaning Procedure

Turn off the main water supply and disconnect the brine line from the control valve. Attach the injection line of the Water Paramedic system to the brine line connection on the water softener control valve. Start a regeneration process and advance the valve to the brine position. Inject the cleaning solution in the control valve is in the brine position. When the entire cleaning solution is injected in the control valve, disconnect the drain line on the top of the control valve and attach the suction line on the Water Paramedic to the drain line connection on the control valve. Change the control valve position on the Water Paramedic to the “Recirculation” position. Turn on the Water Paramedic pump and all the system to recirculate with the cleaning solution. This will help to remove build up and flush the injector/educator in the water softener control valve. Allow the system to recirculate for 20-30 minutes. Turn off the Water Paramedic pump and move the control valve to the suction position. Disconnect the Water Paramedic suction line from the water softener drain line connection and re-connect the drain line to the water softener control valve. Turn on the water supply line and advance the water softener to the backwash position. Allow the system to backwash for 10 minutes and shut off the water supply and turn off the water supply. Proceed to the sanitizing procedure.

### Water Softener Sanitizing Procedures

Anytime a service is performed or a water system and it is opened to the atmosphere, a sanitization process should be performed to ensure there is no cross contamination from tools, hands and ambient air. Sanitizing is expected to ensure organics in the softener are destroyed and the system is biologically safer.

### Sanitizing Procedure

The system should now be in the “brine draw” position after the last step of the cleaning process with the water supply still in the off position. Inject the sanitizing solution in the tank with the water softener control valve in the brine draw position and the Water Paramedic control valve in the suction position. Once the sanitizing solution is in the tank, allow it to rest in the tank for 20-30 minutes. Disconnect the injection line of the Water Paramedic from the water softener control valve and reconnect the brine line to the brine line connection on the water softener valve. Advance the water softener control valve to the “rinse” position and turn on the supply water. Allow the system to rinse for the entire rinse cycle. The valve will then advance to the “brine fill” cycle. Allow the system to operate in the brine fill cycle for 2 minutes and advance the water softener control valve to the service position. The sanitizing process is complete; now initiate a complete regeneration process and allow the water softener to regenerate normally. Be sure there is salt in the brine tank and that there is a concentrated salt solution available for the regeneration process. Once the regeneration process is complete, the water softener is cleaned, sanitized and regenerated. The system is now ready for automatic operation.

### RO Membrane Cleaning Procedures

RO (“reverse osmosis”) membranes can last up to 5 years if the feed water is conditioned properly and the system is not overworked. This lifespan can be increased with a regular cleaning process. The Water Paramedic can be used to clean the RO system membrane and also sanitize the entire system. Some proprietary systems are designed in a way that membranes cannot be cleaned. This is procedure is intended for standard RO systems with removable membranes.

### Membrane Cleaning Procedure

The membrane can be cleaned without disturbing the rest of the system. Turn off the tank valve and the feed water to the RO system and open the faucet to release the pressure. Remove the feed line to the membrane housing and attach it to the Water Paramedic injection line. Remove the flow restrictor on the membrane housing and re-attached the drain line. Plug the permeate port on the membrane housing. Make sure the control valve on the Water Paramedic system is in the “suction” position. Turn on the Water Paramedic pump on and allow the cleaning solution to be introduced to the membrane. Once the bag is empty, turn off the Water Paramedic pump and attach the suction line of the Water Paramedic to the drain line on the membrane housing. Move the control valve on the Water Paramedic system to the “recirculation” position. Turn on the Water Paramedic pump and allow it to recirculate the cleaning solution in the membrane housing for 10 minutes. Shut down the Water Paramedic pump and disconnect the Water Paramedic suction line from the membrane drain line. Reconnect the drain line to the house drain. Disconnect the membrane feed line from the Water Paramedic injection line. Reconnect the membrane feed line on the system to the feed port on the membrane. Turn on the feed water with the faucet closed and the tank valve closed. Do not remove the plug from the membrane permeate line at this time. Allow the membrane to flush to drain with feed water for 5 minutes. Shutoff the water supply to the RO system and reconnect the permeate line and re-install the drain line flow restrictor and drain line. Open the faucet with the feed valve and tank valve in the closed position to release any pressure, then move on to the sanitizing procedure.

### RO System Sanitizing Procedures

Anytime a service is performed or a water system and it is opened to the atmosphere, a sanitization process should be performed to ensure there is no cross contamination from tools, hands and ambient air. Sanitizing is expected to ensure organics in the softener are destroyed and the system is biologically safer.

### Sanitizing Procedure

The feed water valve and the tank valve should be in the off position. Remove the filters and membrane and bypass or remove the post carbon filter. Store the membrane in a Ziploc bag and make sure the membrane is handled with sanitary gloves. Re-install the filter sumps and any lines that were disconnected. Disconnect the feed water line and connect the injection line from the Water Paramedic to the inlet port on the RO system. Shut the faucet and open the tank valve. Allow the tank to empty completely. Plug the RO system drain line. With the control valve on the Water Paramedic in the “suction” position, turn on the pump in the Water Paramedic and inject the sanitizing solution into the RO system. Turn off the pump in the water paramedic system when the sanitizing solution has been injected. Reconnect the feed water line to the RO system and turn on the water to pressurize the tank. Allow the system to rest for 10 minutes and open the faucet for 2 minutes and close the faucet. Allow the system to rest for 10 more minutes, then open the faucet and begin to rinse the system. Allow the system to rinse for 10 minutes then close the faucet and wait 10 minutes. Open the faucet and allow the system to rinse for 10 more minutes. Shut off the feed water and allow the system to de-pressurize. Install new filters and re-install the membrane. Remove the plug from the drain line and reconnect the drain line to the house drain. Re-install the post carbon filter. Open the tank valve and the feed water valve. Open the faucet and allow the system to run until there is a steady stream coming from the RO system faucet. Close the faucet and allow the system to fill (about 2 hours). Then open faucet and flush the tank and system. Repeat the previous step two times to flush the system, tank and new post carbon filter. It is a good practice to check the TDS level after the cleaning, sanitizing and flushing to ensure the RO system is making the most optimal water. If not, the membrane may need to be replaced.

1. A method of cleaning or sanitizing a potable water device, comprising the step of: recirculating a rejuvenation solution through the potable water device.

2. The method of claim 1, wherein the recirculation is a pulsing recirculation.

3. The method of claim 1, wherein air is introduced into the rejuvenation fluid during recirculation to induce agitation.

4. The method of claim 1, further comprising the step of injecting the rejuvenation solution into the potable water device.

5. The method of claim 1, wherein the rejuvenation solution is a cleaning, sanitizing, or descaling solution.

6. The method of claim 1, wherein the potable water device is a water softener, filter, reverse osmosis system, water cooler, water heater, back flow regulator, water dispenser, commercial coffee maker, soda machine, or ice machine.

7. The method of claim 6, wherein the potable water device is a water softener.

8. The method of claim 6, wherein the potable water device is a reverse osmosis system.

9. The method of claim 2, wherein the pulsing recirculation is performed by an external, detachable, portable apparatus comprising: a pump fluidly connected to the potable water device, provided the pump is not a submersible pump.

10. The method of claim 9, wherein the pump is a mechanical pump.

11. An apparatus for cleaning or sanitizing a potable water device, comprising: a pump to recirculate and/or pulsate a rejuvenating solution through the device, provided the pump is not a submersible pump.

12. The apparatus of claim 11, wherein the pump is a mechanical pump.

13. The apparatus of claim 11, wherein the pump is electrically or battery powered.

14. The apparatus of claim 11, wherein the apparatus further comprises detachable means to fluidly connect the pump to the potable water device.

15. The apparatus of claim 11, wherein the apparatus further comprises detachable flexible inlet and outlet tubes to fluidly connect the pump to inlet and outlet ports, respectively, of the potable water device.

16. The apparatus of claim 11, wherein the apparatus further comprises a diverter valve.

17. The apparatus of claim 11, wherein the apparatus further comprises a check valve.

18. The apparatus of claim 11, wherein the apparatus further comprises a solution bag connection fitting.

19. The apparatus of claim 11, wherein the apparatus further comprises a solution bag connection fitting with an integrated check valve.

20. The apparatus of claim 11, wherein the apparatus is portable.
